(19) United States
(12) Patent Application Publication
(10) Pub. No.: US 2021/0001863 A1
(43) Pub. Date: Jan. 7, 2021

(54) DETECTION DEVICE AND DETECTION SYSTEM

(71) Applicant: Isuzu Motors Limited, Tokyo (JP)

(72) Inventor: Ryuuta TSUDA, Fujisawa-shi, Kanagawa (JP)

(73) Assignee: Isuzu Motors Limited, Tokyo (JP)

(21) Appl. No.: 16/980,543

(22) PCT Filed: Mar. 14, 2019
(86) PCT No.: PCT/JP2019/010436

§ 371 Date: Sep. 14, 2020

(30) Foreign Application Priority Data
Mar. 15, 2018 (JP) 2018-047801

(51) Int. Cl. B60W 40/08; G06F 3/01; B60R 11/04

(52) U.S. Cl. CPC B60W 40/08; B60R 11/04; G06F 3/013

(57) ABSTRACT

This detection device comprises: a detection unit that detects the face orientation and/or the gaze orientation of a driver from an image of the driver while driving a vehicle; and a determination unit that determines the position of the head of the driver in the image. The detection unit adjusts the face orientation and/or the gaze orientation to be detected from the image according to the determined position of the head.

### TECHNICAL FIELD

The present disclosure relates to a detection device and a detection system.

### BACKGROUND ART

Conventionally, there is known a device that detects a face orientation and a sight line orientation of a driver based on an image of the driver captured by an image capturing section provided in a vehicle (for example, see Patent Literature (hereinafter, referred to as “PTL”) 1). In this technique, it is detected in accordance with the face orientation whether or not the driver is in a driving incapability state.

### CITATION LIST

### Patent Literature

PTL 1
Japanese Patent Application Laid-Open No. 2016-9256

### SUMMARY OF INVENTION

### Technical Problem

Incidentally, a head position of the driver does not stop at a specific position, for example, at a position near to the front, at a position near to the rear, and the like, and changes depending on the situation during driving, the type of the seat, and the like. On the other hand, since the image capturing section is fixed to the vehicle, the view of the face viewed from the image capturing section changes depending on each head position in a case where the head position of the driver changes.

In the related art, the change in the view of the face in accordance with the change of the head position is not taken into consideration so that the face orientation and the sight line orientation are detected on the assumption that the face of the driver is at a specific position. As a result, even when the face of the driver is directed in a specific direction, the face orientation and the sight line orientation that are different from the specific direction may be detected depending on the head position.

An object of the present disclosure is to provide a detection device and a detection system capable of accurately detecting a face orientation and a sight line orientation of a driver in accordance with a head position.

### Solution to Problem

A detection device according to the present disclosure includes:

a detection section that detects at least one of a face orientation and a sight line orientation of a driver from an image of the driver while driving a vehicle; and

a determination section that determines a head position of the driver in the image, wherein

the detection section adjusts the at least one of the face orientation and the sight line orientation to be detected from the image, in accordance with the head position that is determined.

A detection system according to the present disclosure includes:

an image capturing section that captures the image of the driver; and

the detection device.

### Advantageous Effects of Invention

According to the present disclosure, it is possible to accurately detect a face orientation and a sight line orientation of a driver in accordance with a head position.

### BRIEF DESCRIPTION OF DRAWINGS

FIG. 1 is a block diagram of a detection system according to an embodiment of the present disclosure; and

FIG. 2 is a diagram for describing how a view of a face viewed from an image capturing section changes in accordance with a head position.

### DESCRIPTION OF EMBODIMENTS

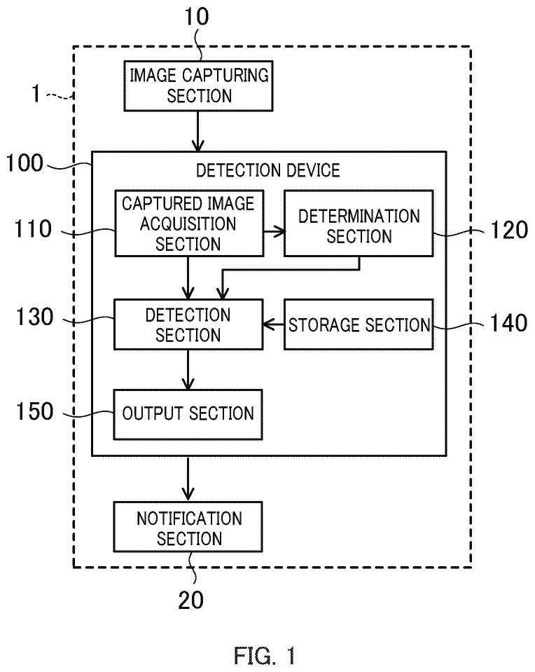

Hereinafter, an embodiment of the present disclosure will be described in detail with reference to the accompanying drawings. FIG. 1 is a block diagram of detection system 1 according to an embodiment of the present disclosure. Note that, in the following description, a traveling direction of a vehicle is referred to simply as “traveling direction”.

As illustrated in FIG. 1, detection system 1 is a system mounted on a vehicle, and detects at least one of a face orientation (hereinafter, referred to as “facial orientation”) and a sight line orientation of a driver seated in the driver's seat. Detection system 1 detects the facial orientation and the sight line orientation of the driver, and notifies the outside of the current driving state of the driver. Note that, in the following description, only the detection of the facial orientation will be described, and a description of the detection of the sight line orientation will be omitted since the contents thereof are the same as those of the detection of the facial orientation.

The facial orientation detected by detection system 1 is, for example, an angle formed by the traveling direction and a direction in which the driver faces. Detection system 1 includes image capturing section 10, notification section 20, and detection device 100.

Image capturing section 10 is, for example, an infrared camera, and is provided on an A-pillar on a side of the driver of the vehicle. Image capturing section 10 captures an image of the driver from an obliquely forward position with respect to the driver. That is, the optical axis of image capturing section 10 does not coincide with the traveling direction. Image capturing section 10 outputs the captured image to detection device 100.

Further, image capturing section 10 includes a light source that emits infrared light and a light receiving section, and detects information on a distance between image capturing section 10 described above and the driver. The information on the distance includes, for example, information on a distance calculated by a time-of-flight method using information on a time until the infrared light emitted by image capturing section 10 is reflected from the driver and returns to image capturing section 10, image processing, and/or the like. Image capturing section 10 outputs the detected information on the distance to detection device 100.

Notification section 20 is, for example, a display section or the like, and notifies the driver or the like of detection information from detection device 100. Specifically, notification section 20 displays, based on the detection information, a notification such as to call the driver's attention in a case where the driver does not look at a predetermined range ahead of the vehicle, but looks away. Note that, notification section 20 may also call the driver's attention by using an alarm, a sound or the like.

Detection device 100 includes a central processing unit (CPU), a read only memory (ROM), a random access memory (RAM), and an input/output circuit, all of which are not illustrated, and is configured to detect the facial orientation of the driver based on a program set in advance. Detection device 100 includes captured image acquisition section 110, determination section 120, detection section 130, storage section 140, and output section 150.

Captured image acquisition section 110 acquires information on the captured image of the driver, which is captured by image capturing section 10, and outputs the information on the captured image to determination section 120 and detection section 130. The information on the captured image includes the image captured by image capturing section 10 as well as, for example, the information on the distance between image capturing section 10 and the driver, and the like.

Determination section 120 determines a head position of the driver in the vehicle in the traveling direction based on the information on the captured image acquired from captured image acquisition section 110. Specifically, determination section 120 estimates the head position of the driver in the vehicle in the traveling direction based on the information on the distance between image capturing section 10 and the driver. Determination section 120 outputs the estimated head position to detection section 130.

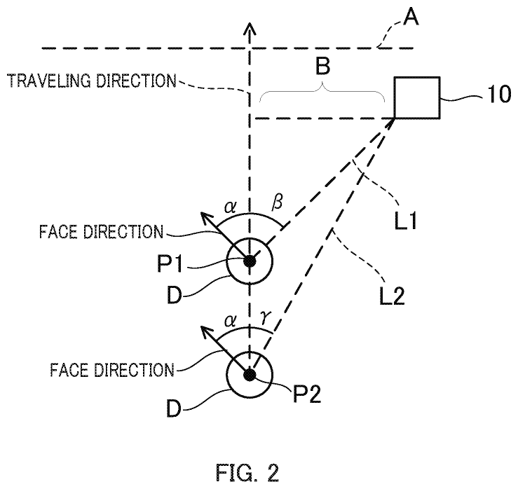

The traveling direction is, for example, a direction orthogonal to a direction along the windshield of the vehicle (dashed line A in FIG. 2) and to the vertical direction, but may also deviate from the above-mentioned direction by approximately one or two degrees. The head position is estimated based on a relationship between the information on the distance between image capturing section 10 and the driver and distance B between image capturing section 10 and the traveling direction (see FIG. 2).

Detection section 130 detects the facial orientation of the driver from the image acquired from captured image acquisition section 110. Specifically, detection section 130 adjusts the facial orientation to be detected from the image, in accordance with the head position determined by determination section 120.

The head position of the driver in the traveling direction does not stop at a specific position, for example, at a position near to the front, at a position near to the rear, and the like, and changes depending on the situation during driving, and the like. For example, when the driver drives carefully while gazing ahead, it is considered that the driver drives the vehicle with the face closer to the windshield. Further, when the driver drives in a relaxed state, it is considered that the driver drives the vehicle with the face away from the windshield, such as by leaning deeply on the seat back. Further, since the position at which it is easy for the driver to drive varies depending on the driver's preference, build, or the like, the head position also changes when the driver is replaced by another driver.

On the other hand, since image capturing section 10 that captures the image of the driver is fixed to the vehicle, the view of the face viewed from image capturing section 10 changes depending on each head position when the head position in the traveling direction of the vehicle changes. Hereinafter, an example in which the view of the face changes at position P1 and at position P2 behind position P1 will be described with reference to FIG. 2. In FIG. 2, each angle formed by the traveling direction and a direction in which the face of the driver is directed (hereinafter, referred to as “face direction”) at positions P1 and P2 is α.

As illustrated in FIG. 2, at position P1, the angle formed by straight line L1 connecting image capturing section 10 and driver D, and the traveling direction is β. At position P2, on the other hand, the angle formed by straight line L2 connecting image capturing section 10 and driver D, and the traveling direction is γ. Since position P2 is farther from image capturing section 10 than position P1, γ is an angle smaller than β.

These angles can be calculated, for example, by using the relationship between the information on the distance between image capturing section 10 and driver D and distance B from image capturing section 10 to the traveling direction in FIG. 2.

Further, the angle formed by straight line L1 and the face direction of driver D at position P1 is α+β, and the angle formed by straight line L2 and the face direction of driver D at position P2 is α+γ. Since these angles are different, it is understood that the view of the face of driver D viewed from image capturing section 10 changes at positions P1 and P2.

Here, for example, when the facial orientation is detected only based on the image acquired by captured image acquisition section 110, the view of the face in image capturing section 10 changes at positions P1 and P2 so that detection device 100 may detect a facial orientation different from the actual facial orientation.

In the present embodiment, however, the facial orientation of driver D is detected in accordance with the image acquired from captured image acquisition section 110 and the head position acquired from determination section 120. That is, although the angles detected by image capturing section 10 are α+β (position P1) and α+γ (position P2), the angles described above are corrected to angles in which a relationship between the position of image capturing section 10 and the head position of driver D is taken into consideration. Specifically, angle α obtained by subtracting angle β formed by straight line L1 and the traveling direction is detected at position P1, and angle α obtained by subtracting angle γ formed by straight line L2 and the traveling direction is detected at position P2. In this way, it is possible to accurately detect the facial orientation in accordance with the head position of driver D.

Further, storage section 140 stores information on a correspondence relationship between the image, the head position, and the facial orientation. The facial orientation in the information is associated with the view of characteristic portions of the face (for example, nose or the like) in the image, and with each head position in the traveling direction. Note that, these associations can be performed by a publicly-known technique.

Upon acquiring an image and a head position, detection section 130 detects the facial orientation by reading out a facial orientation corresponding to the image and the head position from storage section 140.

Output section 150 acquires the facial orientation detected by detection section 130, and outputs the detected facial orientation to notification section 20 of detection system 1. Notifying the outside of the facial orientation detected by detection section 130 thereby makes it possible to quickly call the driver's attention based on information of the above-mentioned facial orientation. Such attention calling is performed, for example, in a case where the facial orientation of the driver is directed in a direction different from the traveling direction, in a case where the facial orientation of the driver is directed even in a direction different from the traveling direction, but is not directed toward a mirror of the vehicle, and the like.

According to the present embodiment configured as described above, the facial orientation of the driver is detected in accordance with the image and the head position, so that it is possible to accurately detect the facial orientation in accordance with the head position.

Further, since image capturing section 10 is disposed on the A-pillar of the vehicle, it is possible to acquire an accurate image without adversely affecting the forward field of vision of the driver. For example, a case where image capturing section 10 is disposed in front of the driver becomes susceptible to influences such as overlapping with sunlight incident from the windshield, a door glass or the like, and an accurate image may not be possibly acquired. In particular, a case of a vehicle with a large windshield, such as a commercial vehicle, is excessively susceptible to the influence of sunlight since sunlight is easily made incident. However, disposing image capturing section 10 on the A-pillar makes it possible to easily avoid the sunlight incident from the windshield, a door glass or the like, and further to acquire an accurate image.

Further, in a case where the driver wears eyeglasses, the infrared light of image capturing section 10 is emitted from the front of the driver when image capturing section 10 is disposed in front of the driver, so that the eyeglasses easily receive the infrared light, and further the infrared light is reflected. As a result, for example, the position of the driver's eyes may not be possibly detected accurately, and further an accurate image may not be possibly detected. However, since the infrared light of image capturing section 10 is emitted from the obliquely forward position with respect to the driver by disposing image capturing section 10 on the A-pillar, it is possible to avoid the reception of the infrared light by the eyeglasses, and further to acquire an accurate image.

Incidentally, in a case where image capturing section 10 is disposed in front of the driver, image capturing section 10 may be disposed at a position interfering with driving operation of the driver, such as steering operation, for convenience of the space in which image capturing section 10 is disposed, which possibly interferes with the driving operation. In the present embodiment, however, disposing image capturing section 10 on the A-pillar makes it possible to restrain the driving operation of the driver from being disturbed while a dead space of the vehicle is effectively utilized.

Note that, in the embodiment described above, the facial orientation is detected by reading out the information on the correspondence relationship between the image, the head position, and the facial orientation from storage section 140, but the present disclosure is not limited thereto. The facial orientation may also be detected by calculating the facial orientation based on the acquired image and head position. Further, the facial orientation may also be detected by correcting a reference value of a facial orientation at a reference position serving as a reference based on an amount of deviation of a head position from the reference position.

Further, although determination section 120 determines the head position of the driver in the traveling direction in the embodiment described above, the present disclosure is not limited thereto. Determination section 120 may determine the head position of the driver in the vertical direction.

Further, although the embodiment described above has exemplified the facial orientation in a case where the face of the driver is directed in the horizontal direction, the present disclosure is not limited thereto. The facial orientation in a case where the face of the driver is directed in the vertical direction may also be employed. In this way, it is possible to call attention not only to the driver's looking away, but also to the driver's doze and driving incapability state.

Further, although the facial orientation is an angle formed by the traveling direction and the face direction in the embodiment described above, the present disclosure is not limited thereto. The facial orientation may also be any parameter as long as the parameter makes it possible to confirm whether the driver looks at a range ahead of the vehicle.

Further, in the embodiment described above, detection system 1 calls the driver's attention with notification section 20 based on the detection information detected by detection device 100, but the present disclosure is not limited thereto. For example, detection system 1 may perform driving support for the driver, such as performing safe traveling control, based on the detection information detected by detection device 100.

Further, although the facial orientation in the traveling direction is detected in the embodiment described above, the present disclosure is not limited thereto. For example, in the case of a vehicle such as a bus, it is possible to call attention to confirmation of safety of passengers getting on and off the vehicle by configuring a facial orientation in a direction facing a road shoulder side when the passengers get on and off.

Further, although image capturing section 10 is provided on the A-pillar of the vehicle in the embodiment described above, the present disclosure is not limited thereto. Image capturing section 10 may also be provided on a center console of the vehicle.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

This application is based upon Japanese Patent Application No. 2018-047801, filed on Mar. 15, 2018, the entire contents of which are incorporated herein by reference.

### INDUSTRIAL APPLICABILITY

The detection device of the present disclosure is useful as a detection device and a detection system capable of accurately detecting a face orientation of a driver in accordance with a head position.

### REFERENCE SIGNS LIST

1 Detection system
10 Image capturing section
20 Notification section
100 Detection device
110 Captured image acquisition section
120 Determination section
130 Detection section
140 Storage section
150 Output section

What is claimed is:

1. A detection device, comprising:
a detection section that detects at least one of a face orientation and a sight line orientation of a driver from an image of the driver while driving a vehicle; and
a determination section that determines a head position of the driver in the image, wherein
the detection section adjusts the at least one of the face orientation and the sight line orientation to be detected from the image, in accordance with the head position that is determined.

2. The detection device according to claim 1, wherein
the determination section estimates the head position in the vehicle based on a distance between an image capturing section and the driver, the image capturing section capturing the image.

3. The detection device according to claim 1, wherein
the face orientation or the sight line orientation of the driver is an orientation with respect to a traveling direction of the vehicle.

4. The detection device according to claim 1, wherein
the determination section determines the head position of the driver in the traveling direction of the vehicle.

5. The detection device according to claim 1, wherein
the image is an image of the driver captured from an obliquely forward position with respect to the driver.

6. The detection device according to claim 1, comprising an output section that outputs information on the at least one of the face orientation and the sight line orientation detected by the detection section.

7. A detection system, comprising:
an image capturing section that captures the image of the driver; and
the detection device according to claim 1.

8. The detection system according to claim 7, wherein
the image capturing section is disposed on an A-pillar of the vehicle or a center console of the vehicle.
